(19) United States
(12) Patent Application Publication
(10) Pub. No.: US 2003/0072607 A1
(43) Pub. Date: Apr. 17, 2003

(54) Method for connecting plastic pieces and the connection between plastic pieces

(76) Inventor: Huei-Ming Wang, Taichung Hsien (TW)

Correspondence Address: Charles E. Baxley, Hart, Baxley, Daniels & Holton, Fifth Floor, 59 John Street, New York, NY, 10038, US

(21) Appl. No.: 10/259,916

(22) Filed: Sep. 30, 2002

(30) Foreign Application Priority Data
Oct. 11, 2001 (TW) 090125061

(51) Int. Cl. F16B 12/04

(52) U.S. Cl. 403/268

(57) ABSTRACT

A method for connecting plastic pieces includes step of setting up the plastic board and the connection piece by facing a first engaging side of the plastic board and a second engaging side of the connection piece; step of setting up the connection member and contacting two sides of the connecting member with the first engaging side and the second engaging side, and step of adhering the two sides of the connection member by adherents to the first engaging side and the second engaging side.

### FIELD OF THE INVENTION

The present invention relates to a method for connecting two plastic pieces by a connection member which is in contact with the plastic pieces and adherent is used to secure the connection.

### BACKGROUND OF THE INVENTION

A conventional way to fix or connect plastic pieces such as a plastic board 11 and the post 12 is shown in FIG. 1, wherein the plastic board 11 and the post 12 are necessary to be drilled with holes 111 and threaded holes 121 respectively so that screws 10 extend through the holes 111 in the plastic board 11 and are engaged with the threaded holes 211 in the post 12. This conventional requires time to drill the holes 111 and 121 by proper tools and if the holes 111 are located close to the edge of the plastic board 11, the plastic board 11 could be cracked. The post 12 also affects the appearance of the whole assembly. FIG. 2 shows another conventional way to connect a plastic board 12 to a post 11. The post 11 has a slot 112 defined therein which receives a side of the plastic board 12 with adherent located between the board 12 and the post 11. It is difficult to connect the two items at an angle or in curve fashion.

The present invention intends to provide a method for connecting the plastic pieces by using a connection member and adherent connected between the two pieces.

### SUMMARY OF THE INVENTION

In accordance with one aspect of the present invention, there is provided a method for connecting a plastic board and a connection piece, the method comprises the following steps:

step 1: setting up the plastic board and the connection piece by arranging a first engaging side of the plastic board in contact with a second engaging side of the connection piece; step 2: setting up the connection member which has two sides in contact with the first engaging side and the second engaging side; step 3: adhering the connection member by adherents to connecting the two sides of the connection member and the first engaging side and the second engaging side.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a first conventional method for connecting a plastic board and a post;

FIG. 2 is an exploded view to show a second conventional method for connecting a plastic board and a post;

FIG. 3 is an exploded view to show the method for connecting a plastic board and a connection piece of the present invention;

FIG. 4 is a cross sectional view to show the connection of the plastic board, the connection member and the plastic board;

FIG. 5 shows the steps of the method of the present invention;

FIG. 6 shows a plastic board is connected to a circular connection piece by the method of the present invention, and

FIG. 7 shows the connection member can be a curve plate.

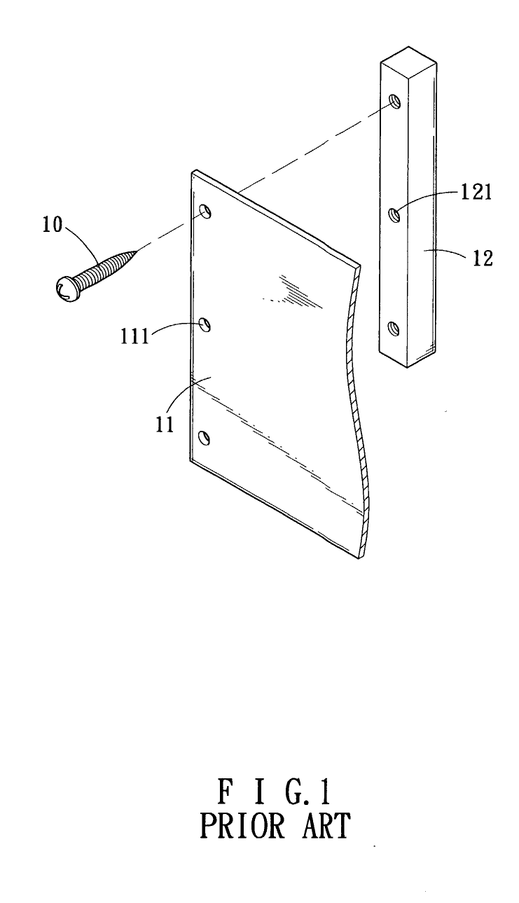

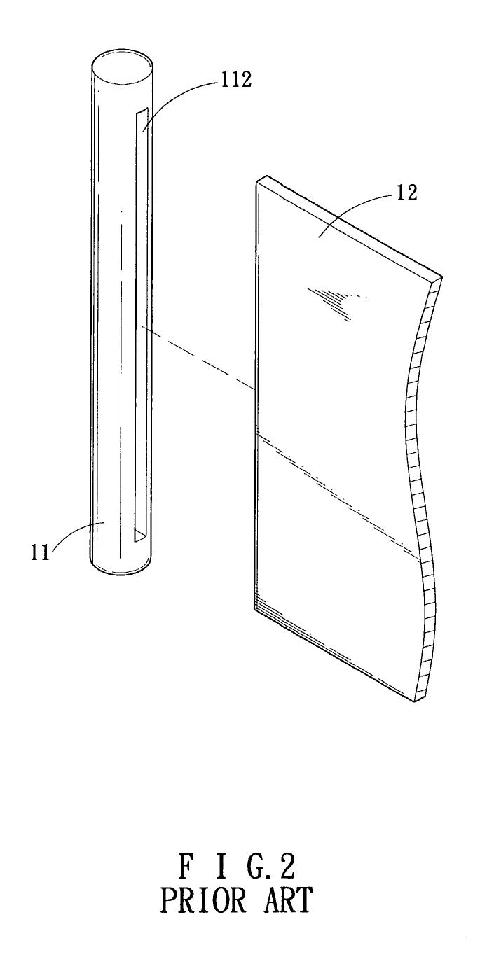

### DETAILED DESCRIPTION OF THE PREFERRED EMBODIMENT

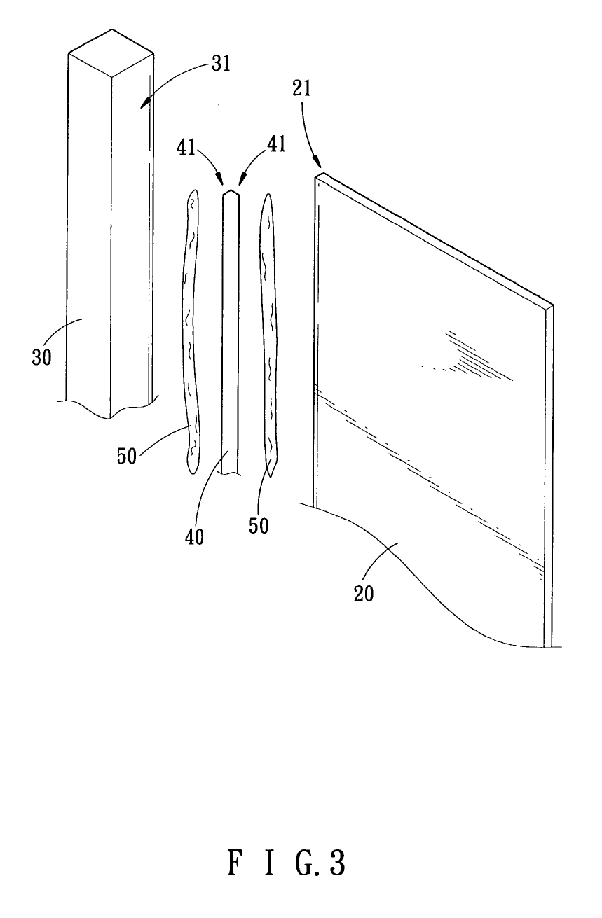

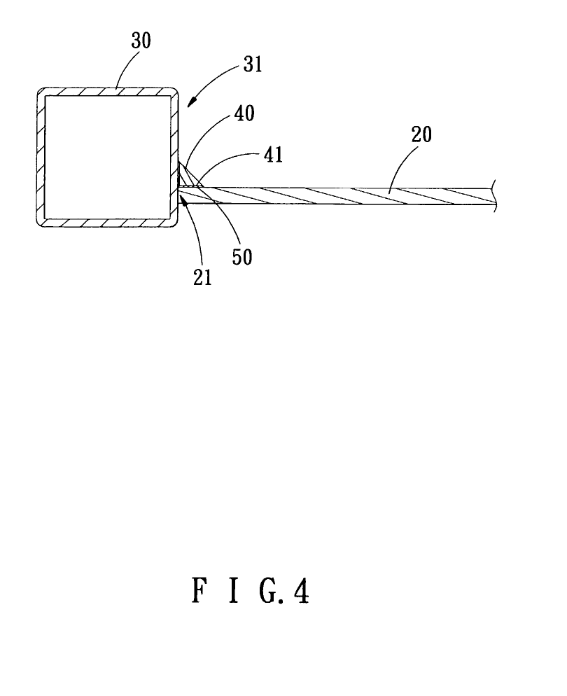

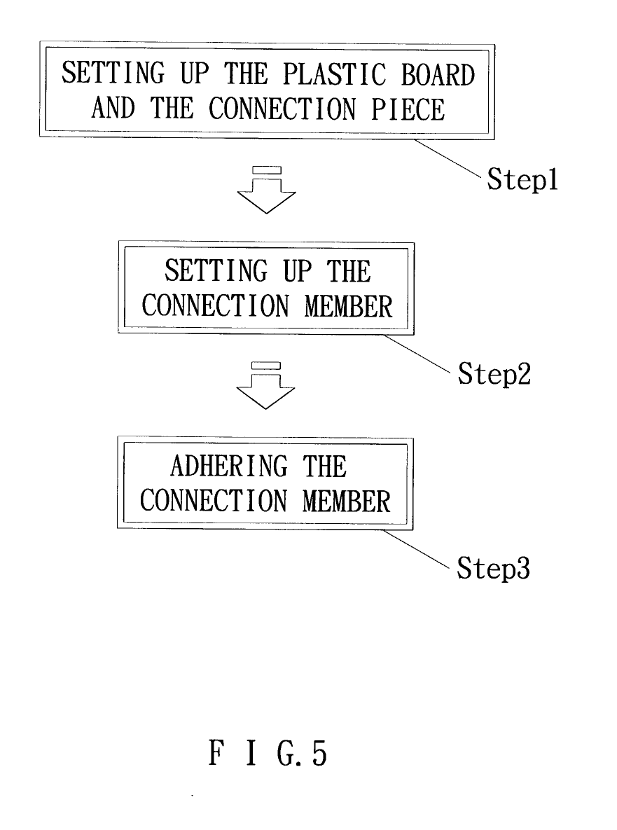

Referring to FIGS. 3 to 5, the method of the present invention comprises a the following steps:

step 1: setting up the plastic board 20 and the connection piece 30:

A first engaging side 21 of the plastic board 20 is in contact with a second engaging side 31 of the connection piece 30.

step 2: setting up the connection member 40:

The connection member 40 is located between the first engaging side 21 of the plastic board 20 and the second engaging side 31 of the connection piece 30. Two sides are in contact with the first engaging side 21 and the second engaging side 31.

step 3: adhering the connection member 40:

By using two adherents 50 to connect the two sides of the connection member 40 and the first engaging side 21 and the second engaging side 31.

It is to be noted that the adherents 50 are not instant glue and can be pressed by exerting a force on the plastic board 20 and the connection piece 30 so as to adjust the plastic board 20, the connection member 40 and the connection piece 30 at their correct positions. The connection portion can be trimmed to have a smooth and neat outer appearance.

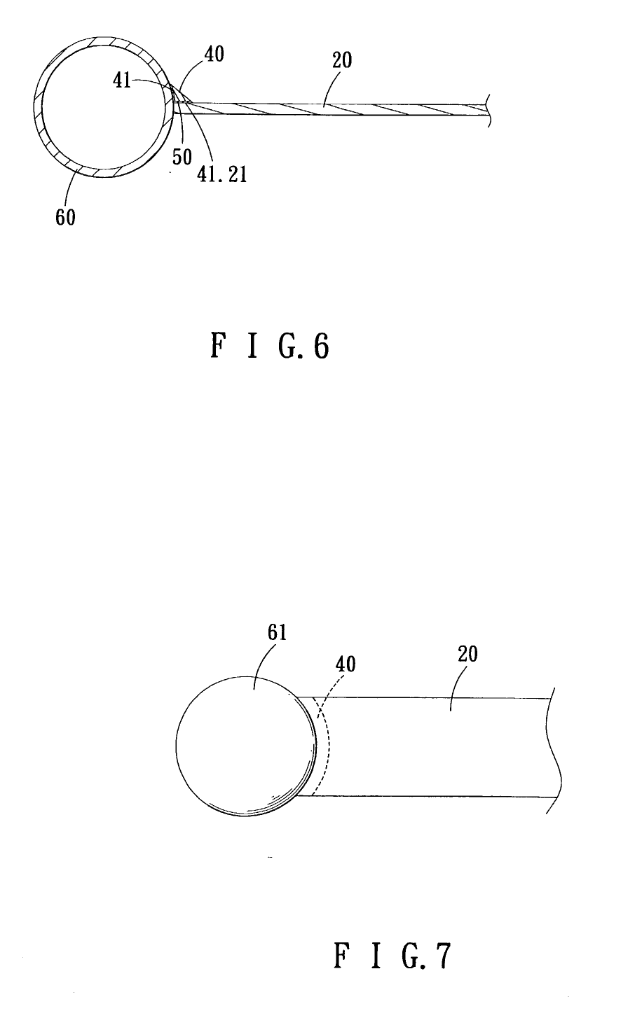

Referring to FIG. 6, the connection piece 60 can be a tubular piece and the connection member 40 may be made by flexible material so as to meet the contour of the connection piece 60. The first engaging side 21 is located at a side of the plastic board 20 and in contact with the side of the connection member 40. FIG. 7 shows that the connection member 40 can be a curve plate which is matched with the outer contour of the tubular connection piece 61 and the curve end of the plastic board 20.

By this method, the assemblers can easily connect the plastic boards 20 and connection pieces 30 of different sizes and shapes by proper connection members 40.

While we have shown and described the embodiment in accordance with the present invention, it should be clear to those skilled in the art that further embodiments may be made without departing from the scope of the present invention.

What is claimed is:

1. A connection of plastic pieces, comprising:
a plastic board having a first engaging side;
a connection piece having a second engaging side which contacts the first engaging side of the plastic board;
at least one tubular connection member having two sides facing the first engaging side and the second engaging respectively, and
two adherents located between one of the two sides of the at least one tubular connection member and the first engaging side, and the other side of the at least one tubular connection member and the second engaging side.

2. A method for connecting a plastic board and a connection piece, comprising the following steps:
step 1: setting up the plastic board and the connection piece:
a first engaging side of the plastic board connecting a second engaging side of the connection piece;
step 2: setting up the connection member:
the connection member is located between the first engaging side and the second engaging side, two sides being in contact with the first engaging side and the second engaging side, and step 3: adhering the connection member:
using adherent to connecting the two sides of the connection member and the first engaging side and the second engaging side.
